(19) United States
(12) Patent Application Publication
(10) Pub. No.: US 2015/0147062 A1
(43) Pub. Date: May 28, 2015

(54) Photonic Integrated Transmitter Device, Photonic Integrated Receiver Device, and Active Optical Cable Transceiver System

(71) Applicant: FCI, Guyancourt (FR)

(72) Inventor: Sven Otte, Hohen Neuendorf (DE)

(73) Assignee: FCI, Guyancourt (FR)

(21) Appl. No.: 14/343,478

(22) PCT Filed: Sep. 10, 2012
(86) PCT No.: PCT/EP2012/003794

§ 371 Date: Apr. 9, 2014

(30) Foreign Application Priority Data
Sep. 9, 2011 (IB) PCT/IB2011/002463

(51) Int. Cl. H04J 14/02; H04B 10/50; H04B 10/60; H04B 10/25

(52) U.S. Cl. CPC H04J 14/02; H04B 10/25; H04B 10/50; H04B 10/60
USPC 398/79

(57) ABSTRACT

A photonic integrated transmitter device (21) is provided, including a substrate, an array of modulated light sources, each light source providing a modulated signal output at a channel wavelength different from the channel wavelength from other modulated light sources of the array of modulated light sources, an optical fiber interface, configured to receive an end portion of an optical fiber cable, and a division-wavelength multiplexer, wherein the division-wavelength multiplexer is provided in the substrate and is optically connected to the array of modulated light sources and the optical fiber interface via a first and second optical waveguide, respectively. Furthermore, a photonic integrated receiver device and an active optical cable transceiver system are provided.

### BACKGROUND

1. Technical Field

The present disclosure relates to a photonic integrated transmitter device, a photonic integrated receiver device, and an active optical cable transceiver system.

2. Brief Description of Prior Developments

Photonic integrated devices are used in optical networks for transmitting and receiving optical signals assigned to data information.

Document WO 2004/034530 A1 discloses a photonic integrated circuit chip comprising an array of modulated sources, each providing a modulated signal output at a channel wavelength different from the channel wavelength of other modulated sources and a wavelength selective combiner having an input optically coupled to receive all the signal outputs from the modulated sources and provided combined output signal on an output waveguide from the chip. The modulated sources, combiner and output waveguide are all integrated on the same chip which in turn is provided on a sub mount carrying additional components such as a modulator driver.

### SUMMARY

It is an object of the invention to provide improved technologies for photonic integrated transmitter/receiver devices having a higher degree of integration.

According to one aspect of the present disclosure, a photonic integrated transmitter device is provided, comprising a substrate, an array of modulated light sources provided on the substrate, each light source providing a modulated signal output at a channel wavelength different from the channel wavelength from other modulated light sources of the array of modulated light sources, an optical fiber interface, provided on the substrate and configured to receive an end portion of an optical fiber cable, and a division-wavelength multiplexer. The division-wavelength multiplexer is provided in the substrate and is optically connected to the array of modulated light sources and the optical fiber interface via a first and second optical waveguide, respectively, the first and second optical waveguides being provided on the substrate.

According to another aspect, a photonic integrated receiver device is provided, comprising a substrate, an array of optical receivers provided on the substrate, an optical fiber interface, provided on the substrate and configured to receive an end portion of an optical fiber cable, and a division-wavelength d-multiplexer, wherein the division-wavelength d-multiplexer is provided in the substrate and is optically connected to the array of optical receivers and the optical fiber interface via a first and second optical waveguide, respectively, the first and second optical waveguides being provided on the substrate. The optical receiver may be mounted on the substrate in a way that a sensitive receiver area is facing the substrate. E.g., the so-called flip-chip technology may be used for assembling the optical receiver on the substrate. Light signals to be coupled onto the sensitive receiver area may be guided by reflection elements provided on the surface of the substrate, thereby, implementing such optical guiding elements in/on the substrate itself.

According to a further aspect, an active optical cable transceiver system is provided, comprising a photonic integrated transmitter device, a photonic integrated receiver device, and an optical fiber. End portions of the optical fiber cable are received in and optically connected to an optical fiber interface of the photonic integrated transmitter device and the photonic integrated receiver device, respectively.

The division-wavelength multiplexer/d-multiplexer is manufactured in the substrate itself, thereby, providing integration of the multiplexer into the substrate. This leads to an implementation of the multiplexer in the substrate. Also, the first and second optical waveguides are integrated into the substrate itself. E.g., light reflection elements may be provided on or realized by the surface of the substrate. In view of the substrate features proposed it also may be referred to as an optical and electrical functional substrate. In conclusion, the photonic integrated transmitter/receiver device provide a higher degree of integration compared to prior art devices.

In the optical fiber interface, the end portion of the optical fiber cable is received. In the end portion the optical fiber(s) of the cable may still be covered by the cover of the cable. But, in a preferred embodiment the optical fiber(s) without any cover may be received in the interface.

The substrate may be made of at least one of the following materials: semiconductor material such as silicon, and polymer material. Independent of the material used, the substrate provides a material “bench” into which functional elements of the transmitter/receiver device are integrated.

In a preferred embodiment, the array of modulated light source comprises a plurality of light sources and a plurality of modulators, each modulator assigned to at least one of the light sources. There are different embodiments for implementing the modulators. In one embodiment, the light emitted by a light source which, for example, is a laser diode will be modulated by a light modulator provided downstream of the light source. For example, an electro optical shutter may be used for light modulation. In an alternative embodiment, a driver current applied to the light source is modulated for generating modulated light signals assigned to data information. The plurality of light sources and/or the plurality of modulators may be assembled on the substrate by the flip-chip technology known as such.

In another embodiment, at least one of the first and second optical waveguides is provided in the substrate. In this embodiment, the first and/or the second optical waveguide are manufactured or implemented in the substrate itself. Again, an additional functional component of the photonic transmitter/receiver device is integrated into the substrate.

In an advanced embodiment, the first waveguide may be provided with a plurality of separated sub-waveguides each assigned to at least one of the modulated light sources.

Preferably, an electrical circuitry may be mounted on an electrical mounting area provided on the substrate, the electrical circuitry being electrically connected to the array of modulated light sources.

A further development provides that one or more driver components each assigned to at least one of the light sources are provided in the electrical circuitry. For example, the driver component assigned to at least one of the light sources provides a driver current for driving the light source.

In a further preferred embodiment, the electrical circuitry may be flip-chip mounted. In this embodiment, the flip-chip technology known as such is used for assembling the electrical circuitry on the substrate.

In still a further preferred embodiment, a coupling element is provided in the substrate, the coupling element being configured to couple the modulated signals from the array of modulated light sources into the first waveguide. In a preferred embodiment, the coupling element comprises a coupling mirror is provided on a tilted surface of the substrate. For example, the tilted surface is provided in a groove of the substrate.

A further development provides that the optical fiber interface is provided with a V-groove provided in the substrate.

### BRIEF DESCRIPTION OF THE DRAWINGS

In the following, the invention will be described in further detail, by way of example, with reference to different embodiments. The figures show:

FIG. 1 a schematic representation of a photonic integrated transmitter device,

FIG. 2 a schematic representation of an active optical transceiver cable system, and

FIG. 3 a schematic representation of an active optical transceiver cable system.

### DETAILED DESCRIPTION OF EMBODIMENT

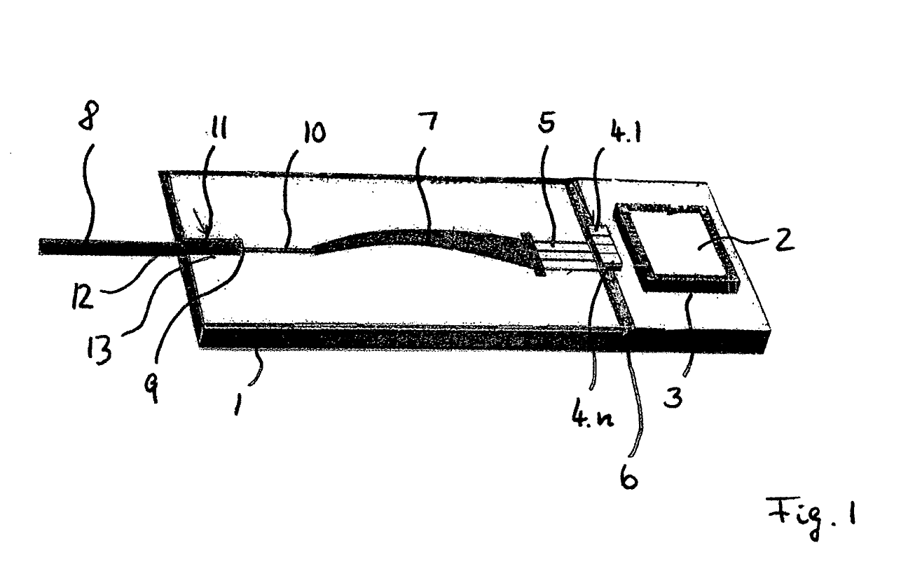

FIG. 1 shows a schematic representation of a photonic integrated transmitter device comprising a substrate 1 made of a semiconductor material or a polymer. The semiconductor material, for example, may be a silicon material. The substrate 1 provides a kind of a material bench for different functional components of the photonic integrated transmitter device, such as electrical and optical components. The photonic integrated transmitter device is configured to generate an integral number of optical channels each having a different centre or peak wavelength by converting electrical signals into optical signals.

The electrical signals are applied to a driver 2 assembled on the substrate 1. The driver 2 is provided on an electrical mounting area 3 on the substrate 1 preferably by the flip-chip technology.

The driver 2 which may be part of an electrical circuitry provided on the substrate 1 is connected to an array for of modulated light sources 4.1, . . . , 4.n. Each of the light sources 4.1, . . . , 4.n provides a modulated optical signal output at the channel wavelength different from the channel wavelengths from the other modulated light sources of the array of modulated light sources 4.1, . . . , 4.n.

The modulated optical signals outputted by the modulated light sources 4.1, . . . , 4.n are coupled into a waveguide 5 by means of a coupling element 6 which is provided with a coupling mirror. In general, the waveguide is a structure which guides electromagnetic waves. In the embodiment shown in FIG. 1, the modulated optical signals are guided to a division-wavelength multiplexer 7 by the waveguide 5 comprising a plurality of sub-waveguides assigned to the modulated light sources 4.1, . . . , 4.n. The division-wavelength multiplexer 7 is manufactured in or implemented into the substrate 1 itself.

By the wavelength-division multiplexer 7 the plurality of modulated optical signals is multiplexed into an optical fiber cable 8. Therefore, the primary function of the wavelength-division multiplexer 7 is to combine the plurality of optical signals provided by the modulated light sources 4.1, . . . , 4.n into a single optical signal which is coupled into a fiber 9 of the optical fiber cable 8 via a further waveguide 10 also provided in the substrate 1.

Referring still to FIG. 1, an end portion 11 of the optical fiber cable 8 is received in an optical fiber cable interface 12 provided with a V-grove 13 in a substrate 1.

In another embodiment (not shown), the photonic integrated device is provided as a photonic integrated receiver device configured to receive one or more optical signals and to convert the optical signal(s) in to one or more electrical signals. Referring to FIG. 1, in such embodiment, instead of the wavelength-division multiplexer 7, a wavelength-division d-multiplexer is provided in the substrate 1. The d-multiplexer is configured to convert a single optical signal received via the further waveguide 10 into a plurality of modulated optical signals, each of the signals having a channel wavelength different from the channel wavelength from the other modulated signal.

Following, the de-modulated optical signals are guided by the waveguide 5 to a plurality of light detecting elements provided on the substrate 1 instead of the modulated light sources 4.1, . . . , 4.n. The received light signals are converted into electrical signals. The plurality of light detecting elements is connected to electrical circuitry assembled on the electrical mounting area 3 instead of the driver 2.

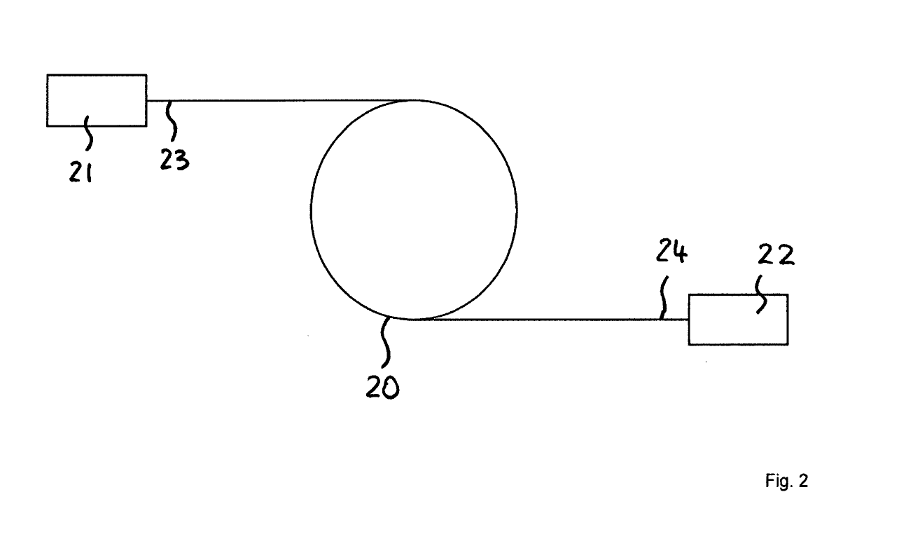

FIG. 2 shows the schematic representation of an active optical cable system comprising an optical fiber cable 20 connected to a photonic integrated transmitter device 21 and a photonic integrated receiver device 22 provided at end portions 23, 24 of the optical fiber cable 20. Comparable to the device shown in FIG. 1, the photonic integrated transmitter device 21 is provided with an array of modulated light sources outputting modulated optical signals to a wavelength-division multiplexer. The array of modulated light sources is electrically connected to a modulator driver which connects to a microcontroller unit. The photonic integrated receiver device 22 is provided with an array of optical detecting devices receiving de-multiplexed optical signals from a wavelength division d-multiplexer. The array of optical detecting elements is electrically connected to a microcontroller unit.

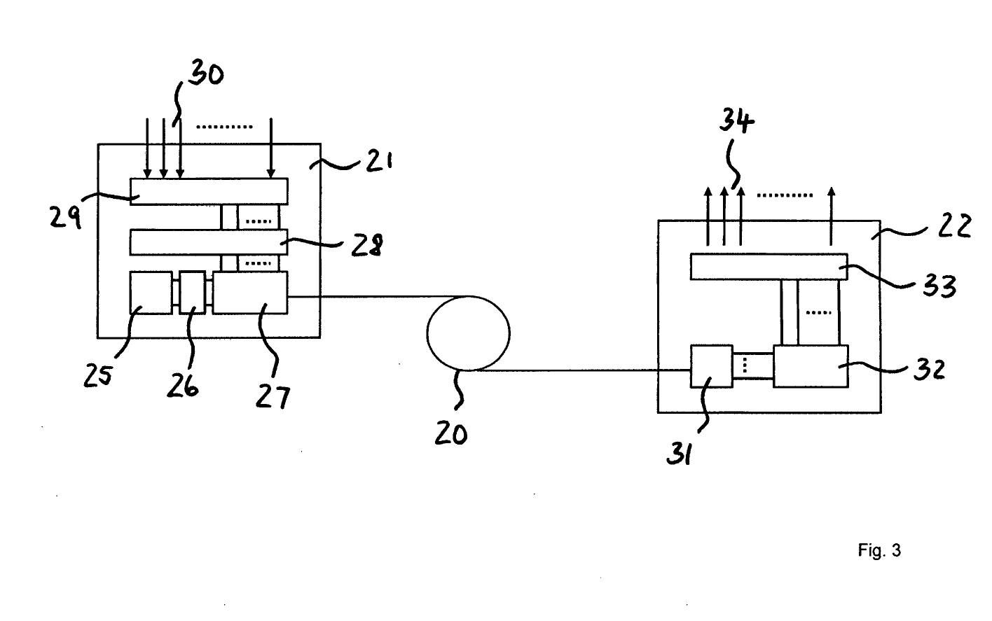

FIG. 3 shows the schematic representation of an embodiment of the active optical cable system shown in FIG. 2 in more detail. The photonic integrated transmitter device 21 and the photonic integrated receiver device 22 provided at end portions 23, 24 are connected by the optical fiber cable 20.

Referring to the photonic integrated transmitter device 21, light emitted by a light source 25, e.g. a cw-laser, is coupled, via an optical multiplexer device 26, to a multi channel modulator device 27 connected to a modulator driver 28. The multiplexer device 26 may be provided with a wavelength-division multiplexer implemented as described above. The modulator driver 27 is connected to a microcontroller unit 29 which receives electrical input signals 30 to be transformed into optical output signals coupled into the optical fiber cable 20.

Turning to the photonic integrated receiver device 22, optical input signals received via the optical fiber cable 20 are provided to d-multiplexer device 31 which may be provided as a wavelength division d-multiplexer. D-multiplexed optical signals are provided from the d-multiplexer device 31 to a multi-channel detector array 32 connected to a further microcontroller unit 33 outputting electrical output signals 34.

Preferably, the photonic integrated transmitter device and a photonic integrated receiver device 21, 22 are configured to handle at least 12 optical channels, each channel carrying modulated optical signals at a channel wavelength different from the channel wavelength(s) from other modulated signals.

The features disclosed in this specification, the figures and/or the claims may be material for the realization of the invention in its various embodiments, taken in isolation or in various combinations thereof.

1. A photonic integrated transmitter device, comprising:
a substrate,
an array of modulated light sources, each light source providing a modulated signal output at a channel wavelength different from the channel wavelength from other modulated light sources of the array of modulated light sources,
an optical fiber interface, configured to receive an end portion of an optical fiber cable, and
a division-wavelength multiplexer,
wherein the division-wavelength multiplexer is provided in the substrate and is optically connected to the array of modulated light sources and the optical fiber interface via a first and second optical waveguide, respectively.

2. Device according to claim 1, wherein the substrate is made of at least one of the following materials: semiconductor material such as silicon, and polymer material.

3. Device according to claim 1, wherein the array of modulated light source comprises a plurality of light sources and a plurality of modulators, each modulator assigned to at least one of the light sources.

4. Device according to claim 1, wherein at least one of the first and second optical waveguides is provided in the substrate.

5. Device according to one claim 1, wherein the first waveguide is provided with a plurality of separated sub-waveguides each assigned to at least one of the modulated light sources.

6. Device according to claim 1, wherein electrical circuitry is mounted on an electrical mounting area provided on the substrate, the electrical circuitry being electrically connected to the array of modulated light sources.

7. Device according to claim 6, wherein one or more driver components each assigned to at least one of the light sources are provided in the electrical circuitry.

8. Device according to claim 6, wherein the electrical circuitry is flip-chip mounted.

9. Device according to claim 1, wherein a coupling element is provided in the substrate, the coupling element being configured to couple the modulated signals from the array of modulated light sources into the first waveguide.

10. Device according to claim 1, wherein the optical fiber interface is provided with a V-groove provided in the substrate.

11. A photonic integrated receiver device, comprising:
a substrate,
an array of optical receivers,
an optical fiber interface, configured to receive an end portion of an optical fiber cable, and
a division-wavelength d-multiplexer,
wherein the division-wavelength d-multiplexer is provided in the substrate and is optically connected to the array of optical receivers and the optical fiber interface via a first and second optical waveguide, respectively.

12. An active optical cable transceiver system, comprising:
a photonic integrated transmitter device as in claim 1,
a photonic integrated receiver device, further comprising:
a substrate,
an array of optical receivers,
an optical fiber interface, configured to receive an end portion of an optical fiber cable, and
a division-wavelength d-multiplexer,
wherein the division-wavelength d-multiplexer is provided in the substrate and is optically connected to the array of optical receivers and the optical fiber interface via a first and second optical waveguide, respectively; and
an optical fiber cable, end portions of the optical fiber cable being received in and optically connected to an optical fiber interface of the photonic integrated transmitter device and the photonic integrated receiver device, respectively.
